(19) United States
(12) Patent Application Publication
(10) Pub. No.: US 2011/0073821 A1
(43) Pub. Date: Mar. 31, 2011

(54) Trailer Jack With Safety Features

(75) Inventor: David B. Nirenberg, Bonita Springs, FL (US)

(73) Assignee: UNIFIED MARINE, INC., Newport, TN (US)

(21) Appl. No.: 12/771,519

(22) Filed: Apr. 30, 2010

Related U.S. Application Data
(60) Provisional application No. 61/174,271, filed on Apr. 30, 2009.

(51) Int. Cl. B60S 9/02

(52) U.S. Cl. 254/420

(57) ABSTRACT

A jack assembly including a jack body sub-assembly and a swivel plate. The jack assembly preferably includes the following indicators: (i) at least one jack extension indicator for indication the extension position of the jack; and/or (ii) a disengagement indicator for indicating disengagement of rotational constraints as between the jack body sub-assembly and the load to which the jack is secured (for example, the swivel plate on the tongue of a trailer). In a preferred embodiment, the fixed-engagement indicator takes the form of a marking on a pin that: (i) engages with a swivel plate to rotationally constrain the jack body with respect to the swivel plate; and (ii) disengages with the swivel plate to allow relative rotation of the jack body relative to the swivel plate.

### RELATED APPLICATION

The present application claims priority to U.S. provisional patent application number 61/174,271, filed on Apr. 30, 2009; all of the foregoing patent-related document(s) are hereby incorporated by reference herein in their respective entirety(ies).

### BACKGROUND OF THE INVENTION

1. Field of the Invention

The present invention relates to trailer jacks and more particularly to trailer jacks that include swivel plates.

2. Description of the Related Art

U.S. Pat. No. 4,056,155 (“Wahl”) discloses a portable scale to be used in conjunction with a jack tube. The Wahl scale includes an elongated slot with calibrated weight indications and a pressure plate. As the pressure plate moves downward in response to applied loads , the applied weight is thereby indicated.

Some conventional trailer jacks include: a swivel plate; a jack mounting bracket; a jack body and a pin (including a stop). The jack mounting bracket is rotationally mechanically connected to the swivel plate. For example, the jack mounting bracket may be connected by a bolt running through the center of the jack mounting bracket so that the bracket can rotate around the bolt. The jack mounting bracket is fixed to the jack body so that the jack body rotates with the jack mounting bracket. In this way, the jack body is rotatable between (i) an in-use position (in most designs this is the vertical position with the bottom of the jack body resting on the ground); and (ii) an out-of-the-way position (in many designs this is a horizontal position with the jack body above the ground and generally parallel to the ground).

The pin is used to secure the jack mounting bracket against rotating when it is desired to keep the jack in either the in-use position (i) or the out-of-the-way position (ii). More specifically, there are holes in the jack mounting bracket and the swivel plate. The holes (or at least two of them) will come into alignment when the jack mounting bracket is rotated into the in-use position (i) or the out-of-the-way position (ii). The pin is inserted through aligned holes in the swivel plate and the jack mounting bracket to prevent further rotation of the jack mounting bracket until such time as the pin is removed. In some conventional designs, this pin is U-shaped so that each arm of the “U” passes through its own set of aligned holes. In some conventional designs the pin is slidably mechanically connected to the mounting bracket in a biased manner so that the bias will force the pin in the direction of engaging with the mounting plate.

There are many types of pins that provide an disengagable, rotatable mechanical connection between the jack body (for example the jack mounting bracket and the load securing hardware (for example, the swivel plate). In addition to the U-shaped pin described above, there are single prong pins, J-shaped pins (where the hook portion of the J-shape provides a sort of handle for the user), pins that screws in an out and so on. With respect to the motion required for engagement and disengagement, many pins travel along a direction parallel to the axis of rotation of the jack body, but this is not necessarily required. Further with respect to the motion required for engagement and disengagement, many pins travel along a straight line, but this is not necessarily required.

Other publications which may be of interest may include the following: (i) U.S. patent application 2009/0107735 (“Cleary”); (ii) U.S. patent application 2009/0057633 (“Beck”); (iii) U.S. Pat. No. 7,111,863 (“Ward”); and/or (iv) U.S. Pat. No. 4,589,632 (“Smith”).

Description Of the Related Art Section Disclaimer: To the extent that specific publications are discussed above in this Description of the Related Art Section, these discussions should not be taken as an admission that the discussed publications (for example, published patents) are prior art for patent law purposes. For example, some or all of the discussed publications may not be sufficiently early in time, may not reflect subject matter developed early enough in time and/or may not be sufficiently enabling so as to amount to prior art for patent law purposes. To the extent that specific publications are discussed above in this Description of the Related Art Section, they are all hereby incorporated by reference into this document in their respective entirety(ies).

### BRIEF SUMMARY OF THE INVENTION

The inventor(s) of the present invention have recognized two potential disadvantages in the prior art as follows: (i) a user may falsely believe that the pin(s) are engaged with the swivel plate (and rotation of the mounting bracket with respect to the swivel plate is prevented) when the pin(s) are really not engaged with the swivel plate (and rotation of the mounting bracket with respect to the swivel plate is not really prevented); and (ii) the user may crank the jack too far up, without realizing this, with the result that the stability of the jack body is potentially compromised. In addition to recognizing these problems, the inventor(s) of the present invention have invented a way to help cope with each of these problems. Specifically: (i) a warning indication (for example a red marking) may be located on the pin to visually indicate that the pin is not fully engaged with the swivel plate; and (ii) warning indication(s) (for example, red and orange markings) may be located on a telescoping portion of the jack body to visually indicate that the jack body has been extended to, and/or close to, its maximally extended position.

While it is conventionally thought to be sufficient and optimal to determine pin engagement by merely “eye-balling” the pin, the jack mounting bracket, the swivel plate and/or the angular alignment between the components of the jack assembly, the inventor(s) of the present invention have recognized that this casual, conventional method is not necessarily good enough and that there is room for improvement. If the pin is not fully engaged with the swivel plate, then the jack body can rotate. This is problematic if the jack is meant to be in the out-of-the-way position because the jack can rotate and hit things, or otherwise get in the way. Non-engagement of the pin is even more important if the jack is meant to be in the in-use position because the jack may give way after it is loaded, thereby creating a dangerous condition.

As far as the problem of the user extending the jack too far, so that it is too close to its maximally extended position for safe usage, this overextension creates a potential for damage to or failure of the jack. The jack overextension warnings provided by the present invention are potentially helpful in at least a couple of ways. First, if the jack load (for example, trailer tongue) cannot be sufficiently raised without a warning indication that the jack is overextended, then the user will know that she needs to either re-align the swivel plate, or else get a bigger jack. According to the present invention, one preferred way of indicating actual overextension is the use of a red marking. Second, if the user is jacking up a load (for example, turning the jack's crank) then it can be helpful for the user to know that an overextended state is being approached, even before the jack is actually overextended. For example, upon seeing a warning that an overextended state is being approached, the user might decide to slow down the extending of the jack and check to see whether the jack can sufficiently raise the load without being extended into an overextended condition. According to the present invention, one preferred way of warning that the jack is approaching an overextended condition is the use of a yellow caution marking.

Various embodiments of the present invention may exhibit one or more of the following objects, features and/or advantages:

(i) indication of jack lift height so that users can tell when jacking up is approaching an/or has reached maximum safe operating height;

(ii) indicator on locking pin handle lets users know to forbear from applying force when the locking pin handle is not fully engaged with the swivel plate;

(iii) prevents incorrect attempts at jack loading made when mounting bracket is not rotationally secured;

(iv) prevents inadvertently unsecured jack to freely rotate when not bearing a load;

(v) enhanced safety;

(vi) prevent damage to the jack or trailer caused by an over-extended jack; and

(vii) inform users that the swivel plate requires re-alignment.

According to a first aspect of the present invention, a trailer jack assembly includes: a jack body, jack extension hardware, and first jack extension indicator hardware. The jack extension hardware is structured, located and/or connected to drive the jack body to extend and retract between at least a first normal-operation position, a first overextended position and a plurality of intermediate positions between the first normal-operation position and the first overextended position. The first jack extension indicator hardware is structured, located and/or connected to provide an indication indicating information regarding a current extension position of the jack body.

According to a further aspect of the present invention, a trailer jack assembly for being connected to load securing hardware, includes: a jack body sub-assembly; securing hardware; and disengagement indicator hardware. The securing hardware is structured, sized, shaped and/or located and/or connected so that when it is used to mechanically connect the jack body sub-assembly to the load securing hardware: (i) the jack body is rotationally mechanically connected to the load securing hardware when the securing hardware is disengaged, and (ii) the jack body is at least substantially fixed to the load securing hardware when the securing hardware is engaged. The disengagement indicator hardware is structured, located and/or connected to provide an indication that the jack body is disengaged.

According to a further aspect of the present invention, a trailer jack assembly for being connected to load securing hardware, includes: a jack body sub-assembly; securing hardware; and disengagement indicator hardware. The jack body sub-assembly includes jack extension hardware and first jack extension indicator hardware. The jack extension hardware is structured, located and/or connected to drive the jack body to extend and retract between at least a first normal-operation position, a first overextended position and a plurality of intermediate positions between the first normal-operation position and the first overextended position. The first jack extension indicator hardware is structured, located and/or connected to provide an indication indicating information regarding a current extension position of the jack body. The securing hardware is structured, sized, shaped and/or located and/or connected so that when it is used to mechanically connect the jack body sub-assembly to the load securing hardware: (i) the jack body is rotationally mechanically connected to the load securing hardware when the securing hardware is disengaged, and (ii) the jack body is at least substantially fixed to the load securing hardware when the securing hardware is engaged. The disengagement indicator hardware is structured, located and/or connected to provide an indication that the jack body is disengaged.

### BRIEF DESCRIPTION OF THE DRAWINGS

The present invention will be more fully understood and appreciated by reading the following Detailed Description in conjunction with the accompanying drawings, in which:

FIG. 1 is a perspective view of a first embodiment of a trailer jack assembly (that is, jack and swivel plate) according to the present invention;

FIG. 2 is a perspective detail view of a portion of the first embodiment jack assembly in a freely-rotating status;

FIG. 3 is a perspective detail view of a portion of the first embodiment jack assembly in its in-use position;

FIG. 4 is an orthographic front view of the first embodiment jack assembly in its out-of-the-way position;

FIG. 5 is an orthographic front view of the first embodiment jack assembly in its in-use position.

FIG. 6 is a orthographic front view of a portion of a second embodiment jack assembly according to the present invention;

FIG. 7 is a perspective view of a portion of the second embodiment jack assembly;

FIG. 8 is a perspective view of a portion of the second embodiment jack assembly; and

FIG. 9 is an orthographic front view of a portion of the second embodiment jack assembly.

### DETAILED DESCRIPTION OF THE INVENTION

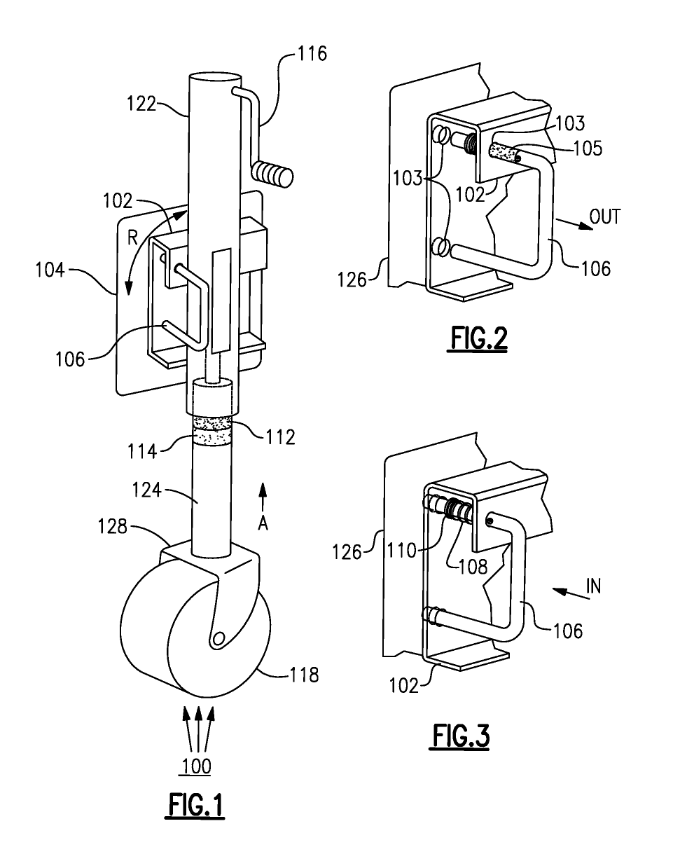

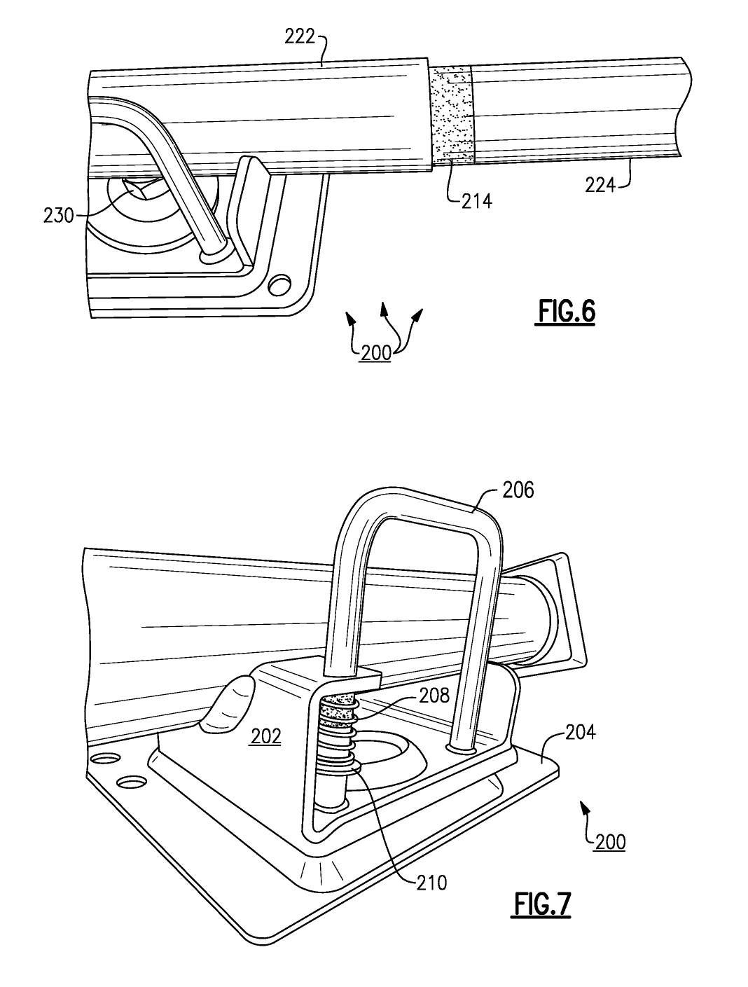

FIGS. 1 to 5 show trailer jack assembly 100, including: mounting bracket 102; swivel plate 104; locking handle 106; crank 116; wheel 118; outer telescoping member 122; inner telescoping member 124; swivel plate 126; and wheel mounting bracket 128. Mounting bracket 102 includes three pin holes 103. Swivel plate 104 include four pinholes 107. Handle 106 includes: first indicator marking 105; stop 108; and spring 110. Inner telescoping member 124 includes: first indicator marking 114; and second indicator marking 112. As shown in FIGS. 4 and 5, the jack body is rotatable between an out-of-the-way position (see FIG. 4), which is up off of the ground, and an in-use position (see FIG. 5, with wheel 118 resting down on the ground. In order to rotate the jack body between these two positions, pin 106 is temporarily pulled (against its bias) out of swivel plate 104, and then allowed to re-engage (under the force of its bias) with the swivel plate once the jack body has been rotated into the currently-desired desired position. When the jack is in the in-use position, crank 116 (see FIG. 1) is forced to turn by a user in order to raise or lower the inner telescoping member and the swivel plate. In this way, jack 100 can be used to raise or lower an object attached to the swivel plate, such as the tongue of a trailer for carrying a boat.

As shown in FIG. 1, the jack includes an indicator of jack height. In this example, first indicator 114 on inner telescoping member 124 is an orange colored band, and second indicator 112 on inner telescoping member 124 is a red colored band. When the jack is in a relatively low position, the inner telescoping member is telescoped deep into outer telescoping member 122, and, consequently, neither of the colored bands are visible because they are inside the outer telescoping member. As the user cranks the jack, the inner telescoping member telescopes out of the outer telescoping member and the orange band begins to be exposed. This visual indication serves as a warning to the user that the jack is beginning to approach its maximally extended position. As the user keeps turning the crank, and as shown in FIG. 1, the inner telescoping member will continue telescoping out of the outer telescoping member so that the red band becomes visible. This is a stronger warning to the user and indicates that the jack should be lowered a bit so that the telescoping juncture of the jack body does not become compromised, or fail, as the jack and the trailer it helps support are towed over terrain.

Alternatively, three or four colored zones could be used on the inner telescoping member, but two colored zones provides three operating regimes (background jack color, orange and red) and is preferred. Although the inner telescoping member is the lower member of jack 100, in alternative embodiments, the inner telescoping member could be the upper telescoping member. the jack body may include more than two telescoping members. The present invention is especially amenable to jacks with telescoping jack bodies because the telescoping movement provides a convenient place to locate a visual indication of jack height. In alternative, not necessarily preferred embodiments of the present invention, there may be no telescoping members, such as in a bellows type jack. In this case, an visual indication of jack height would most likely need to take the form of an indicator separate from the jack body, such as a dial readout or an electronic readout. In still other alternative embodiments, the indication of jack height might be non-visual, such as a sound or a wireless signal sent to a nearby personal digital assistant.

In jack 100, it is the telescoping action of the telescoping members of the jack body that serves to directly cover and directly uncover the visual indication of jack height. In other embodiments, there may be some kind of extraneous sensor that detects the position and/or movement of jack components in order to trigger the indication(s) of jack height. For example, a position sensor could be placed inside the body of a telescoping jack to detect the relative position of the inner and outer telescoping members. As a further example, the turning of the crank could be mechanically connected through a gear train to a dial indicator for the indication of jack height on an ongoing basis.

Now that the indication(s) of jack height aspect of the present invention has been discussed, discussion will proceed to the aspect of indication of engagement between the jack and the swivel plate. In jack 100, it is specifically jack mounting bracket 102 that engages with the swivel plate 104, but in alternative embodiments the jack body itself could be directly engagable with the swivel plate without the presence of a separate jack mounting bracket.

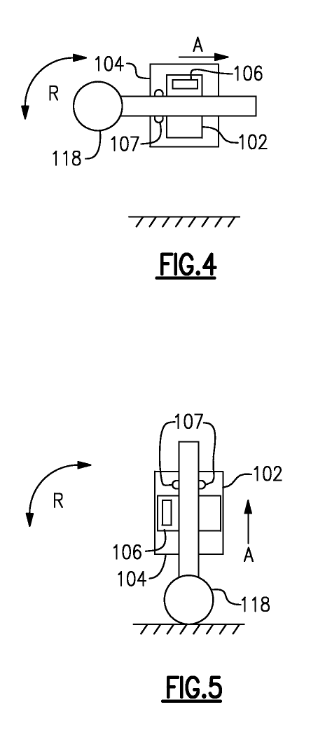

In jack 100, mounting plate 102 (which is rigidly connected to outer telescoping member 122 by welding or the like) is mechanically connected to the swivel plate in two ways: (i) by a central bolt (now shown in the embodiment of FIGS. 1 to 5, but see FIG. 6 at reference numeral 230) and (ii) by pin 106. More specifically, the central bolt provides a relatively permanent mechanical connection between the swivel plate and the mounting plate, but the bolt does not restrain relative rotation of the mounting plate with respect to the swivel plate in the direction of double arrow R (see FIGS. 1, 4 and 5). In other words, the bolt always remains in place even as the bracket and jack body are rotated repeatedly between the in-use and out-of-way positions shown in FIGS. 4 and 5. For present purposes the focus is on the mechanical connection provided by pin 106. FIG. 2 shows the pin in a disengaged position, and FIG. 3 shows the pin in the engaged position. In the disengaged position of the pin shown in FIG. 2, the bracket is free to rotate in the direction of double arrow R with respect to the swivel plate. In the engaged position of the pin shown in FIG. 3, each arm of the pin extends through pinholes 103 of the bracket and aligned, corresponding pinholes 107 (see FIGS. 4 and 5) in the swivel plate. (In some embodiments the swivel plate may have slots or mere recesses, rather than holes.)

As is conventional, spring 108 biases pin 106 in the direction of arrow “IN” (see FIG. 3). However, unless the arms of pin 106 are aligned with one of the sets of pinholes 107 in swivel plate 104 (see FIGS. 4 and 5), the body of the swivel plate will block the inwards direction movement forced by the bias of spring 108 and the pin and bracket will remain in the disengaged position so that these components remain free to rotate about the bolt (not shown). When the arms of pin 106 do come into alignment with one of the two sets of pinholes 107 in the swivel plate, then the biasing force of the spring will push the tips of the arms inwards into the aligned pinholes and the pin will move into the engaged position of FIG. 3 so that the bracket is constrained from rotating out of its current position (in-use position or out-of-the-way position). In other embodiments, the pin may have fewer (that is, one) arms or more arms. In other embodiments, the pin may not have any bias or biasing mechanism. In other embodiments, the pin may always remain in engagement with the swivel plate, rather than always remaining in engagement with the mounting bracket, as in jack 100. In other embodiments, the pin may be built into the jack body, rather than a separate mounting bracket. In the present document, the term “pin mounting portion” shall be used to refer to the portion of the jack in which the pin is mounted and/or engagable, regardless of whether this pin mounting portion is located in the jack body itself, in a separate mounting bracket, or both.

According to the present invention, an indication of engagement between the jack body and the swivel plate is provided. In the preferred embodiment of jack 100, this engagement is provided by a pin, but in other embodiments it could be provided by other hardware, such as a latch. In the preferred embodiment of jack 100, the indication of engagement is a red marking, denominated as first indicator marking 105, which: (i) disappears from view into the interior space of mounting bracket 102 when the pin is engaged (see FIG. 3); but (ii) visibly extends out of bracket 102 when the pin is disengaged (see FIG. 2). In other embodiments, there may be other types of visual indications of engagement, such as a dial or electronic readout. In other embodiments, there may be non-visual indications of engagement and/or disengagement, such as an audible signals, or a wireless data signal to a nearby personal digital assistant device.

FIGS. 6 to 9 show a jack assembly 200 according to the present invention including: jack mounting bracket 202; swivel plate 204; pin-engagement marking 205; pin 206; spring 208; stop 210; overextension indication marking 212; near-overextension indicator marking 214; outer telescoping member 222; inner telescoping member 224; and bolt sub-assembly 230. Jack assembly 200 is generally similar to jack assembly 100, discussed above, and features common two the two assemblies will not be further discussed in the discussion of assembly 200.

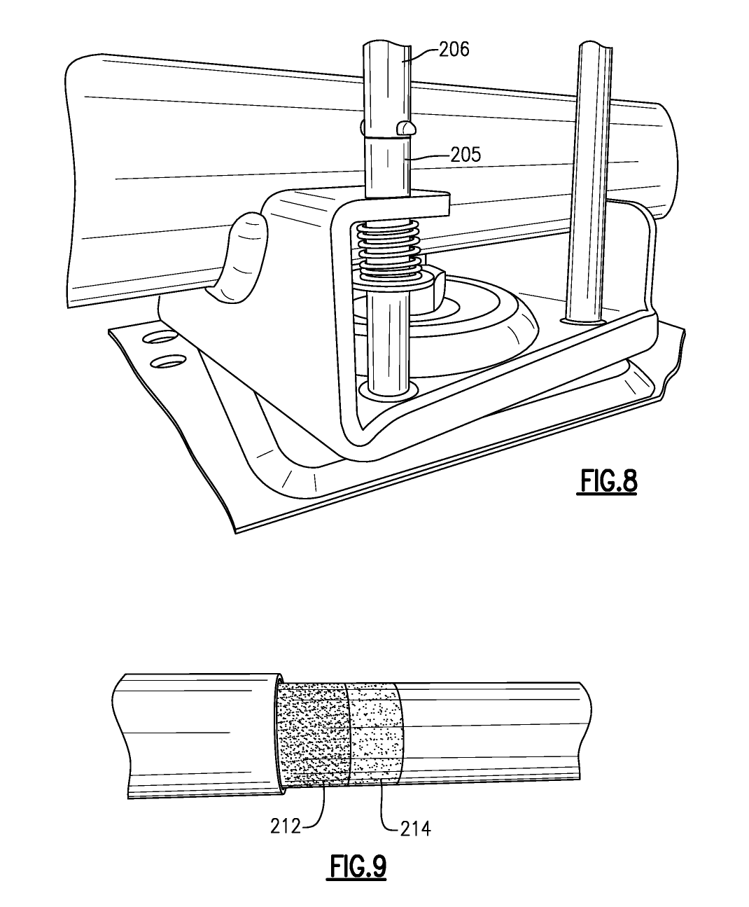

By comparing FIGS. 7 and 8, it can be seen how pin-engagement marking is only visible when the pin is disengaged (see FIG. 7) and is hidden behind the jack mounting bracket and spring when the pin is engaged with the swivel plate. As bet shown in FIG. 9, the overextension related indicators have text in addition to color. More specifically: (i) the near-overextension indicator is yellow and has the word “warning” printed on it; and (ii) the overextension indicator is red and has the word “stop” printed on it. In other preferred embodiments the jack extension indicator markings may include, or be constituted by, a numerical scale indicating the height of some jack assembly component (for example the center of the swivel plate) above the ground (for example, the bottom of the wheel.

FIG. 6 shows a portion of the bolt assembly 230 which provides the rotatable mechanical connection between the jack mounting bracket and the swivel plate. More specifically, FIG. 6 shows a portion of the nut that is threadably engaged with the bolt that holds the jack mounting bracket to the swivel plate in a manner so that the jack mounting bracket is still free to rotate.

### DEFINITIONS

The following definitions are provided to facilitate claim interpretation:

Present invention: means at least some embodiments of the present invention; references to various feature(s) of the “present invention” throughout this document do not mean that all claimed embodiments or methods include the referenced feature(s).

First, second, third, etc. (“ordinals”): Unless otherwise noted, ordinals only serve to distinguish or identify (e.g., various members of a group); the mere use of ordinals implies neither a consecutive numerical limit nor a serial limitation.

Mechanically connected: Includes both direct mechanical connections, and indirect mechanical connections made through intermediate components; includes rigid mechanical connections as well as mechanical connection that allows for relative motion between the mechanically connected components; includes, but is not limited, to welded connections, solder connections, connections by fasteners (for example, nails, bolts, screws, nuts, hook-and-loop fasteners, knots, rivets, force fit connections, friction fit connections, connections secured by engagement added by gravitational forces, quick-release connections, pivoting or rotatable connections, slidable mechanical connections, latches and/or magnetic connections).

Rotationally mechanically connected: mechanically connected so that the connected components are free to rotate relative to each other.

Load securing hardware: includes, but is not necessarily limited to:

To the extent that the definitions provided above are consistent with ordinary, plain, and accustomed meanings (as generally shown by documents such as dictionaries and/or technical lexicons), the above definitions shall be considered supplemental in nature. To the extent that the definitions provided above are inconsistent with ordinary, plain, and accustomed meanings (as generally shown by documents such as dictionaries and/or technical lexicons), the above definitions shall control. If the definitions provided above are broader than the ordinary, plain, and accustomed meanings in some aspect, then the above definitions shall be considered to broaden the claim accordingly.

To the extent that a patentee may act as its own lexicographer under applicable law, it is hereby further directed that all words appearing in the claims section, except for the above-defined words, shall take on their ordinary, plain, and accustomed meanings (as generally shown by documents such as dictionaries and/or technical lexicons), and shall not be considered to be specially defined in this specification. In the situation where a word or term used in the claims has more than one alternative ordinary, plain and accustomed meaning, the broadest definition that is consistent with technological feasibility and not directly inconsistent with the specification shall control.

Unless otherwise explicitly provided in the claim language, steps in method steps or process claims need only be performed in the same time order as the order the steps are recited in the claim only to the extent that impossibility or extreme feasibility problems dictate that the recited step order (or portion of the recited step order) be used. This broad interpretation with respect to step order is to be used regardless of whether the alternative time ordering(s) of the claimed steps is particularly mentioned or discussed in this document.

What is claimed is:

1. A trailer jack assembly comprising:
a jack body;
jack extension hardware; and
first jack extension indicator hardware;
wherein:
the jack extension hardware is structured, located and/or connected to drive the jack body to extend and retract between at least a first normal-operation position, a first overextended position and a plurality of intermediate positions between the first normal-operation position and the first overextended position; and
the first jack extension indicator hardware is structured, located and/or connected to provide an indication indicating information regarding a current extension position of the jack body.

2. The assembly of claim 1 wherein the first jack extension indicator hardware is structured, located and/or connected to provide an indication indicating that the current extension position of the jack body is in the first overextended position.

3. The assembly of claim 1 wherein the first jack extension indicator hardware is structured, located and/or connected to provide an indication indicating that the current extension position of the jack body is close to the first overextended position.

4. The assembly of claim 1 further comprising second jack extension indicator hardware structured, located and/or connected to provide an indication indicating that the current extension position of the jack body is in the first overextended position;
wherein the first jack extension indicator hardware is structured, located and/or connected to provide an indication indicating that the current extension position of the jack body is close to the first overextended position.

5. The assembly of claim 1 wherein:
the jack body comprises and inner telescoping member and an outer telescoping member;
the jack extension hardware is structured, located and/or connected to drive the jack body to extend and retract by changing the amount that the inner telescoping member is telescoped into the outer telescoping member; and
the first jack extension indicator hardware is a marking located on the inner telescoping member that only becomes visible when the inner telescoping is sufficiently telescoped out of the outer telescoping member.

6. The assembly of claim 5 wherein the jack extension hardware comprises a crank that is structured and located to be driven to rotate by a user of the jack assembly to cause extension and retraction of the jack body.

7. The assembly of claim 6 wherein the jack body further comprises:
a wheel; and
a wheel mounting bracket for rotationally mechanically connecting the wheel to an end of the inner telescoping member.

8. The assembly of claim 6 comprising a jack body sub-assembly comprising the jack body, the jack extension hardware; the jack extension indicator, first jack extension indicator hardware and a jack mounting bracket.

9. The assembly of claim 8 further comprising load securing hardware, with the jack body sub-assembly and the load securing hardware being mechanically connected to each other.

10. The assembly of claim 9 wherein the load securing hardware comprises a swivel plate.

11. A trailer jack assembly for being connected to load securing hardware, the trailer jack assembly comprising:
a jack body sub-assembly;
securing hardware; and
disengagement indicator hardware;
wherein:
the securing hardware is structured, sized, shaped and/or located and/or connected so that when it is used to mechanically connect the jack body sub-assembly to the load securing hardware: (i) the jack body is rotationally mechanically connected to the load securing hardware when the securing hardware is disengaged, and (ii) the jack body is at least substantially fixed to the load securing hardware when the securing hardware is engaged; and
the disengagement indicator hardware is structured, located and/or connected to provide an indication that the jack body is disengaged.

12. The assembly of claim 11 wherein:
the jack body sub-assembly comprises a jack mounting bracket;
the securing hardware comprises a bolt sub-assembly and a pin;
the bolt sub-assembly is structured, sized, shaped, located and/or and threadably engagable so that it can rotationally mechanically connect the jack mounting bracket to the load securing hardware;
the pin is structured, sized, shaped, located and/or connected so that when the jack assembly is connected to the load securing assembly the pin can move between: (i) at least one engaged position(s) where the load securing hardware is engaged and the jack body sub-assembly is fixed with respect to the load securing hardware, and (ii) at least one disengaged position(s) where the load securing hardware is disengaged and the jack body sub-assembly is free to rotate with respect to the load securing hardware; and
the disengagement indicator hardware is a marking on the pin that is located to be: (i) exposed when the pin is in a disengaged position, and (ii) at least substantially hidden from view when the pin is in an engaged position.

13. The assembly of claim 12 wherein:
the pin is generally U-shaped; and
the disengagement indicator hardware is located on at least one of the arms of the U-shape.

14. The assembly of claim 12 wherein
the securing hardware further comprises pin-connecting hardware; and
the pin-connecting hardware mechanically connects the pin to the jack mounting bracket so that the pin is biased toward the at least one engaged position(s).

15. The assembly of claim 14 wherein:
the pin-connecting hardware comprises a spring and an stop; and
the stop is mechanically connected to the pin; and
the spring is located between the jack mounting bracket and the stop so that the spring biases the pin toward the at least one engaged position(s).

16. The assembly of claim 12 wherein:
the at least one engaged position(s) include: (i) an in-use position, and (ii) an out-of-the-way position;
when the pin is in the in-use position then an end of the jack body sub-assembly will be located to rest on the ground and the jack body sub-assembly will support the load securing hardware against the force of gravity; and
when the pin is in the out-of-the-way position then jack body sub-assembly suspended off of the ground and will not support the load securing hardware against the force of gravity.

17. The assembly of claim 12 wherein:
a jack body sub-assembly comprises jack extension hardware, an inner telescoping member and an outer telescoping member; and
the jack extension hardware is structured, located and/or connected to drive the jack body to extend and retract by changing the amount that the inner telescoping member is telescoped into the outer telescoping member.

18. The assembly of claim 17 wherein the jack body further comprises:
a wheel; and
a wheel mounting bracket for rotationally mechanically connecting the wheel to an end of the inner telescoping member.

19. A trailer jack assembly for being connected to load securing hardware, the trailer jack assembly comprising:
a jack body sub-assembly comprising jack extension hardware and first jack extension indicator hardware;
securing hardware; and
disengagement indicator hardware;
wherein:
the jack extension hardware is structured, located and/or connected to drive the jack body to extend and retract between at least a first normal-operation position, a first overextended position and a plurality of intermediate positions between the first normal-operation position and the first overextended position;
the first jack extension indicator hardware is structured, located and/or connected to provide an indication indicating information regarding a current extension position of the jack body;
the securing hardware is structured, sized, shaped and/or located and/or connected so that when it is used to mechanically connect the jack body sub-assembly to the load securing hardware: (i) the jack body is rotationally mechanically connected to the load securing hardware when the securing hardware is disengaged, and (ii) the jack body is at least substantially fixed to the load securing hardware when the securing hardware is engaged; and
the disengagement indicator hardware is structured, located and/or connected to provide an indication that the jack body is disengaged.
